(19) United States
(12) Patent Application Publication
(10) Pub. No.: US 2010/0138152 A1
(43) Pub. Date: Jun. 3, 2010

(54) Electromagnetic beam-forming antennas underwater

(76) Inventors: Mark Rhodes, West Lothian (GB); Brendan Hyland, Edinburgh (GB)

Correspondence Address: Goodwin Procter LLP;Attn: Patent Administrator, 135 Commonwealth Drive, Menlo Park, CA, 94025-1105, US

(21) Appl. No.: 12/597,786

(22) PCT Filed: Apr. 29, 2008
(86) PCT No.: PCT/GB08/01497

§ 371 Date: Feb. 4, 2010

(30) Foreign Application Priority Data
May 3, 2007 (GB) 0708512.9

(51) Int. Cl. H04B 13/02; H01Q 1/04; G01S 13/00

(52) U.S. Cl. 701/207; 343/719; 342/22

(57) ABSTRACT

An underwater communication system comprising a transmitter for transmitting information using an electromagnetic and/or magneto-electric transmit antenna and a receiver for receiving information using an electromagnetic and/or magneto-electric receive antenna, at least one of the transmit and receive antennas comprising a plurality of antenna elements which collectively use field superposition and interference to form composite field patterns, beams or shapes and wherein one or both the transmit antenna and receive antenna are underwater.

### INTRODUCTION

The present invention describes a method to form a radiation pattern and/or a field distribution pattern of electromagnetic and/or magneto-electric fields when operating wholly or partially underwater for purposes including communication, navigation and sensing.

### BACKGROUND

Recent increases in underwater operations have brought diverse associated requirements for communication amongst vehicles, machinery, equipment, instrumentation and people, all or some of which may be underwater when communicating. In addition, requirements for related activities such as navigation and remote sensing of objects have arisen. Although certain means of underwater communication are well known, the nature of the underwater environment severely limits the performance of communication methods conventionally adopted in air or free space. Such methods include electromagnetic and/or magneto-inductive communication, which possesses capabilities that lead it to be preferred for certain applications underwater. For example, it is immune to turbidity that restricts useful optical communication; and to noise, reflection and refraction effects, which limit acoustic communication. However, although electromagnetic communication underwater appears superficially similar to that in air or free space, the forms of antennas adopted are generally significantly different for a variety of reasons, and the properties of the water medium are also considerably different. Discussion of this and other aspects of communication underwater are disclosed in our co-pending patent application “Underwater Telecommunications”, PCT/GB2006/002123, and the details of this are hereby incorporated by reference.

While offering advantages, one drawback to be considered in electromagnetic and/or magneto-electric communication is the relatively rapid amplitude attenuation of signals with distance, an effect which results from distributed power dissipation arising due to the partially conductive character of water as a propagation medium. Unlike free-space or air, which have essentially no conductivity, typical fresh water in rivers and lakes has a conductivity of around 0.01 S/m (Siemens/metre) or less, and sea water has much greater conductivity of around 4 S/m, with some dependence on salinity and temperature.

Theoretical analysis and practical experiment both show that such conductivity of the transmission medium gives rise to high signal attenuation encountered over distance when using electromagnetic and/or magneto-electric methods. Consequently, techniques are highly desirable which will maximise the signal strength at a receive site some distance from a transmitter. In some other applications, it may be important to configure fields, which provide other patterns of field distribution, which meet a particular need, such as a degree of omni-directionality over some plane or surface.

### SUMMARY OF THE INVENTION

According to the present invention, there is provided a data communication system comprising a transmitter for transmitting information using electromagnetic and/or magneto-electric transmit antenna, and a receiver for receiving information using a receive antenna, wherein the transmit and receive antennas are formed of a plurality of antenna elements which collectively use field superposition and interference to form field patterns, beams or shapes and wherein one or both the transmit antenna and receive antenna are underwater. Preferably, the field patterns are such as to maximise the signal at the receiver.

The antenna elements that individually have the characteristics of antennas, are typically distributed in an array of physical positions and may be fed with separate signals from the transmitter, which may be arranged to have differing delays or relative phases, and sometimes differing amplitudes. At distant points, a receiver and its associated antenna will detect an aggregate combination of signals, where the combination is a vector sum of the components. The resultant combined signal will vary with both the distance and angular positions of the receiver.

The magnitude and phase of the received signal at any particular receive position will depend (amongst other factors) on the relative geometrical positions of the transmit array of antenna elements, the individual field patterns from each antenna element, the wavelength of the signals, the propagation velocity of the signals in water (in turn dependent on wavelength, itself a function of water permittivity and conductivity), the particular phases and amplitudes of the signals which the antenna elements have been given, and the direction and distance of the receive point from the transmit array.

One or both of the transmit and receive antennas may be underwater and, for the purpose of description, are considered a part of their associated transmitter or receiver. Typically, the antennas are as magnetically coupled conduction loops, but other types of antenna are not excluded.

Arrays of antenna elements are well known in beam-forming applications in radio and radar systems operating in air or free space. In an important aspect of this invention, it is disclosed how related principles may be used in underwater communication where the propagation properties are different from air or free space, and that they may be adapted to different types of antenna more appropriate for underwater electromagnetic and magneto-inductive operation.

According to another aspect of the invention, there is provided a composite transmit antenna or a composite receive antenna comprising a plurality of electromagnetic and/or magneto-inductive antenna elements arranged to be operative mutually underwater. Preferably, the antenna elements are electrically insulted. One or more of the antenna elements may comprise a conductive loop antenna.

The antenna elements may have physical parameters can be changed to alter its field pattern. The field pattern may be changed by altering the phase and/or amplitude of signals fed to or from one or more of the antenna elements.

The antenna arrays may be employed for the purpose of communicating information and/or sensing the presence of an object underwater and/or navigation underwater.

### BRIEF DESCRIPTION OF THE DRAWING

FIG. 1 shows a communication system with one possible array of antenna elements at a transmitter, including a representation of the field contributions from the elements.

### DETAILED DESCRIPTION OF THE INVENTION

The present invention relates to a method by which a plurality of antenna array elements can create a field pattern in both near-field and far-field components and can be arranged to have a desirable form or shape when operating wholly or partially underwater. Typically, but not exclusively, the field shape will be formed to maximise the signal detected by a distant receiver positioned in a known direction from the antenna array.

Loop antennas, whose advantages are disclosed in PCT/GB2006/002123, are usually the preferable type to be adopted in the underwater applications typically envisioned. These, or other types of antenna, create field patterns that can be analysed readily and predicted by those familiar with electromagnetic field theory. These analytic techniques are well established but have not previously been applied in field theory textbooks to an underwater environment where the propagation and field properties are mathematically more complex. In particular, the field shapes differ considerably in the conductive underwater medium and, in this environment near-field components must be taken into account for effective communication. By combining the fields of a number of array elements and taking account of their relative positions, the wavelength of the signals (which in water is very different from in air), and the relative phases and amplitudes of the signals delivered to the antenna elements, mathematical analysis can predict an aggregate field pattern. By appropriate design, it is possible to create particular field patterns which are advantageous for certain purposes, the most common of which is maximisation of the field at a distant receive point.

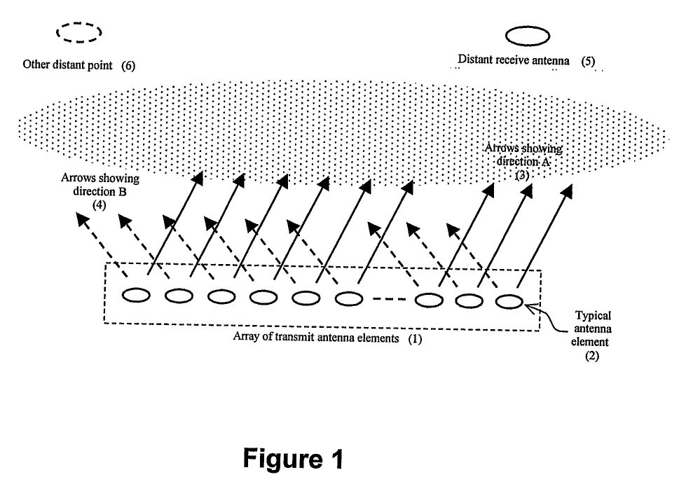

FIG. 1 shows an array of transmit antenna elements 1 formed of individual elements 2. Although a linear array of elements is shown for simplicity, other arrangements of elements may be appropriate. Proper representation of fields in amplitude and phase cannot be accomplished adequately on paper. However, in this example the bold arrows shown 3 in direction A represent field components which aggregate to interfere constructively such as to maximise field strength in the vicinity of distant receiver 5. In contrast, dashed arrows shown 4 in example direction B represent field components, which in aggregate produce only a weak field in the vicinity of a distant point 6. Other directions are not represented but may be designed to have aggregate signal strengths of various degrees dependent on application.

Each antenna element may be a waterproof, electrically insulated magnetic coupled antenna, for example a conductive loop antenna. A magnetic coupled antenna is used because water is an electrically conducting medium, and so has a significant impact on the propagation of electromagnetic signals. Ideally, each insulated antenna assembly is surrounded by a low conductivity medium that is impedance matched to the propagation medium, for example distilled water. In applications where long distance transmission is required, the magnetic antenna should preferably be used at lowest achievable signal frequency. This is because signal attenuation in water increases as a function of increasing frequency. Hence, minimising the carrier frequency where possible allows the transmission distance to be maximised. In practice, the lowest achievable signal frequency will be a function of the desired bit rate and the required distance of transmission.

As previously noted, the particular aggregate field pattern (in distance and angles) from an array of antenna elements is a function of a number of parameters. Methods of finite element analysis (as a practical substitute for analytical mathematics) are well known to those skilled in electromagnetic systems and may be employed in design to calculate and define the field pattern appropriate for a particular application. However, because of the unusual conductive nature of the water medium, adaptation of the usual electric and magnetic field equations is required. While these more complex equations are well known, they apparently have not been applied hitherto to arrays of antenna elements underwater. For proper and complete representation of the fields, both near-field and far-field components must be taken into account. Near-field components are important for low frequency loop antennas used underwater, but this hitherto has not generally been a requirement for arrays of antenna elements in air, because only far-field (propagating) components have been necessary in applications such as radar antennas. The calculations required in finite element analysis underwater are arduous, but amenable to computer methods. The field pattern of each application will have different requirements and require detailed analysis.

In the theory of antennas, the principle of reciprocity is well known and states that the field pattern of a transmit antenna also applies to a receive antenna of the same construction and operation. Consequently, an array antenna of the type described will often be advantageous also in a receive application, and perhaps may be appropriate for both transmit and receive locations.

Although most of the foregoing description has adopted a transmit-receive communication link as an example application for this invention, it will be apparent that the method may be applied to any situation underwater or partly underwater where a shaped field pattern is required including, but not limited to, navigation and remote sensing applications. Furthermore, although described for a medium wholly or partly water, this invention also applies advantageously to any other partially conductive medium. It will be understood that the description and examples given are representative only, and that many other related applications and implementations come within the scope of this invention.

1. An underwater communication system comprising a transmitter for transmitting information using an electromagnetic and/or magneto-electric transmit antenna and a receiver having a receive antenna, at least one of the transmit and receive antennas comprising a plurality of antenna elements which collectively use field superposition and interference to form field patterns, beams or shapes and wherein one or both the transmit antenna and receive antenna are underwater.

2. A composite transmit antenna or a composite receive antenna comprising a plurality of electromagnetic and/or magneto-inductive antenna elements arranged to be operative mutually underwater.

3. A transmit antenna or receive antenna as in claim 2, wherein one or more of the antenna elements comprises a conductive loop antenna.

4. A transmit antenna or receive antenna as in claim 2 whose physical parameters can be changed to alter its field pattern.

5. A transmit antenna or receive antenna as in claim 3, wherein the field pattern is changed by altering the phase and/or amplitude of signals fed to or from one or more of the antenna elements.

6. A transmit antenna or receive antenna according to claim 2, differing in that the medium is partially conductive but other than water.

7. A system for communication of information which includes at least one of a transmit antenna or a receive antenna as in claim 6.

8. A communication system as in claim 7, wherein only one of the transmit antenna and receive antenna is underwater.

9. A system incorporating the antennas of claim 2, employed for the purpose of sensing the presence of an object underwater.

10. A system incorporating the antennas of claim 2, employed for the purpose of position navigation underwater.
